(19) United States
(12) Patent Application Publication
(10) Pub. No.: US 2015/0106791 A1
(43) Pub. Date: Apr. 16, 2015

(54) SYSTEM AND METHOD FOR AUTOMATING BUILD DEPLOYMENT AND TESTING PROCESSES

(71) Applicant: COGNIZANT TECHNOLOGY SOLUTIONS INDIA PVT. LTD., Chennai (IN)

(72) Inventors: Prabakaran Karuppiah, Bangalore (IN); John Wilson Raj Perianayagam, Chennai (IN)

(73) Assignee: COGNIZANT TECHNOLOGY SOLUTIONS INDIA PVT. LTD., Chennai (IN)

(21) Appl. No.: 14/098,765

(22) Filed: Dec. 6, 2013

(30) Foreign Application Priority Data
Oct. 14, 2013 (IN) 4617/CHE/2013

(51) Int. Cl. G06F 11/36

(52) U.S. Cl. CPC G06F 11/3688
USPC 717/127

(57) ABSTRACT

A system and computer-implemented method for automating build deployment and testing processes related to development of software is provided. The system comprises a user interface configured to facilitate users to provide input parameters for build deployment and testing. The system further comprises a build manager configured to facilitate deploying code if the users provide the input parameters related to build deployment. Further, the system comprises a scheduler configured to schedule execution of test scripts for testing the code based on the input parameters. Furthermore, the system comprises a run manager configured to assign the test scripts to testing machines for execution based on execution schedule, monitor execution status of the test scripts and send the execution status to test management systems and the users via communication channels. In addition, the system comprises a reporting module configured to generate reports related to build deployment and test scripts execution.

### FIELD OF THE INVENTION

The present invention relates generally to software testing. More particularly, the present invention provides a web based system and method for automating build deployment and testing processes related to development of software.

### BACKGROUND OF THE INVENTION

In software testing, test scripts are a set of instructions written using a scripting or programming language such as C++, C#, Tcl, Expect, Java, Hypertext Preprocessor (PHP), Perl, Powershell, Python and Ruby. The test scripts are executed on a system under test to verify that the system/computer program/application/product being tested performs in an expected manner.

Conventionally, various systems and methods exist for automatic test scripts execution to facilitate testing. For example, various test management systems facilitate in executing the test scripts on one or more testing machines. However, as the testing machines are also used for manual execution of the test cases by the testers, the testing machines are often unavailable or available for limited duration for automatic test scripts execution. Also, automatic test scripts execution often fails due to heavy load on the testing environment, slower response time and test environment downtime leading to ineffectiveness of the automatic test scripts execution. In addition, if a testing machine does not respond during automatic test scripts execution then rest of the test scripts assigned to the testing machine are also not executed. Further, in case test environment isolation is required, the testers have to manually access each of the testing machines to stop automatic test scripts execution. Furthermore, additional testing machines are often required when large number of test scripts are to be executed.

In light of the abovementioned disadvantages, there is a need for a web based system and method for automating build deployment and testing processes related to development of software. Also, there is a need for a system and method for scheduling test scripts execution and dynamically assigning the test scripts to the one or more testing machines based on availability thereby achieving effective load distribution. In addition, there is a need for a system and method to re-assign the test scripts to a different testing machine in case a particular testing machine does not respond or halts during automatic test scripts execution. Further, there is a need for a system and method that provides options to pause and re-start test scripts execution across all the testing machines thereby facilitating test environment isolation. Furthermore, there is a need for a system and method that provides test scripts execution status and reports via one or more communication channels to facilitate remote monitoring of test scripts execution. Also, there is a need for a system and method that facilitates quality engineering and ensures test effectiveness.

### SUMMARY OF THE INVENTION

A system and computer-implemented method for automating build deployment and testing processes related to development of software is provided. The system comprises a user interface configured to facilitate one or more users to provide one or more input parameters for build deployment and testing. The system further comprises a build manager configured to facilitate deploying code if the one or more users provide the one or more input parameters related to build deployment. Further, the system comprises a scheduler configured to schedule execution of one or more test scripts for testing the code based on the one or more input parameters provided by the one or more users. Furthermore, the system comprises a run manager configured to assign the one or more test scripts to one or more testing machines for execution based on execution schedule, monitor execution status of each of the one or more test scripts and send the execution status to one or more test management systems and the one or more users via one or more communication channels. In addition, the system comprises a reporting module configured to generate one or more reports related to build deployment and test scripts execution.

In an embodiment of the present invention, assigning the one or more test scripts to the one or more testing machines is based on availability of the one or more testing machines to facilitate effective load distribution. In an embodiment of the present invention, the system further comprises a quality engineering module configured to check at least one of: quality and coverage of the code and further configured to generate at least one of: code quality reports and code coverage results. In an embodiment of the present invention, the system further comprises a test effectiveness module configured to determine test effectiveness and further configured to generate test effectiveness results. In an embodiment of the present invention, the system further comprises an impact analyzer configured to analyze the one or more test scripts scheduled for execution and remove one or more duplicated test scripts.

In an embodiment of the present invention, the one or more test scripts are used to verify the code associated with a system under test. In an embodiment of the present invention, the one or more testing machines reside in one or more testing environments. In an embodiment of the present invention, the one or more input parameters include at least one of: project selection, selecting build and deployment options, date and time of execution of test scripts, duration of execution, release notes, information to identify the appropriate test scripts for execution and any other information relevant for test scripts execution. In an embodiment of the present invention, the execution schedule generated by the scheduler contains at least information related to time and order of execution of each of the one or more test scripts. In an embodiment of the present invention, monitoring the execution status of each of the one or more test scripts comprise at least one of: monitoring each of the one or more testing machines, tracking availability of each of the one or more testing machines and re-assigning the one or more test scripts to one or more testing machines.

In an embodiment of the present invention, the run manager provides options to the one or more users to pause and re-start test scripts execution via the user interface. In an embodiment of the present invention, the run manager is configured to re-assign the one or more test scripts being executed to one or more different testing machines if the one or more test scripts halt during execution. In an embodiment of the present invention, the execution status comprise at least one of: information related to number of executed test scripts, number of failed test scripts, execution time, running test scripts, pending test scripts and testing machines utilization. In an embodiment of the present invention, the one or more communication channels include at least one of: electronic mail, Short Messaging Service (SMS), facsimile and Unstructured Supplementary Data Service (USSD). In an embodiment of the present invention, the one or more reports related to test scripts execution include at least one of: running test scripts report, pending test scripts report, executed test scripts report, execution time report, test comparison report, test scripts failure report, defect trend report and testing machine utilization report.

The computer-implemented method for automating build deployment and testing processes related to development of software, via program instructions stored in a memory and executed by a processor, comprises facilitating one or more users to provide one or more input parameters for build deployment and testing. The computer-implemented method further comprises facilitating deploying code if the one or more users provide the one or more input parameters related to build deployment. Furthermore, the computer-implemented method comprises scheduling execution of one or more test scripts for testing the code based on the one or more input parameters provided by the one or more users. In addition, the computer-implemented method comprises assigning the one or more test scripts to one or more testing machines for execution based on execution schedule and monitoring execution status of each of the one or more test scripts. Also, the computer-implemented method comprises sending the execution status to one or more test management systems and the one or more users via one or more communication channels. Further, the computer-implemented method comprises generating one or more reports related to build deployment and test scripts execution.

In an embodiment of the present invention, the computer-implemented method further comprises analyzing the one or more test scripts scheduled for execution and removing one or more duplicated test scripts. In an embodiment of the present invention, the computer-implemented method further comprises checking at least one of: quality and coverage of the code and generating at least one of: code quality reports and code coverage results. In an embodiment of the present invention, the computer-implemented method further comprises determining test effectiveness and generating test effectiveness results. In an embodiment of the present invention, the computer-implemented method further comprising facilitating the one or more users to access the one or more reports related to build deployment and test scripts execution. In an embodiment of the present invention, the one or more users provide the one or more input parameters by sending one or more standard messages via one or more communication channels including at least one of: Short Messaging Service (SMS) and electronic mail. In an embodiment of the present invention, monitoring the execution status of each of the one or more test scripts comprise at least one of: monitoring each of the one or more testing machines, tracking availability of each of the one or more testing machines and re-assigning the one or more test scripts to different testing machines. In an embodiment of the present invention, the computer-implemented method further comprises re-assigning at least one of: the one or more test scripts being executed to one or more different testing machines if the one or more test scripts halt during execution. In an embodiment of the present invention, the execution status comprise at least one of: information related to number of executed test scripts, number of failed test scripts, execution time, running test scripts, pending test scripts and testing machines utilization.

A computer program product for automating build deployment and testing processes related to development of software is provided. The computer program product comprises a non-transitory computer-readable medium having computer-readable program code stored thereon, the computer-readable program code comprising instructions that when executed by a processor, cause the processor to facilitate one or more users to provide one or more input parameters for build deployment and testing. The processor further facilitates deploying code if the one or more users provide the one or more input parameters related to build deployment. Furthermore, the processor schedules execution of one or more test scripts for testing the code based on the one or more input parameters provided by the one or more users. In addition, the processor assigns the one or more test scripts to one or more testing machines for execution based on execution schedule and monitors execution status of each of the one or more test scripts. Also, the processor sends the execution status to one or more test management systems and the one or more users via one or more communication channels. Further, the processor generates one or more reports related to build deployment and test scripts execution.

### BRIEF DESCRIPTION OF THE ACCOMPANYING DRAWINGS

The present invention is described by way of embodiments illustrated in the accompanying drawings wherein:

FIG. 1 is a block diagram illustrating a web based system for automating build deployment and testing processes related to development of software, in accordance with an embodiment of the present invention;

FIG. 2 illustrates an exemplary architecture framework for automating build deployment and testing processes related to development of software, in accordance with an embodiment of the present invention;

FIGS. 3A and 3B represent a flowchart illustrating a method for automating build deployment and testing processes related to development of software, in accordance with an embodiment of the present invention; and

FIG. 4 illustrates an exemplary computer system in which various embodiments of the present invention may be implemented.

### DETAILED DESCRIPTION OF THE INVENTION

A web based system and method for automating build deployment and testing processes related to development of software is provided. The invention provides for a system and method to schedule test scripts execution and dynamically assign test scripts to the one or more testing machines based on availability thereby achieving effective load distribution. Further, the invention provides for a system and method to re-assign the test scripts to a different testing machine in case a particular testing machine does not respond during automated test scripts execution. Furthermore, the invention provides for a system and method that provides options to pause and re-start test scripts execution across one or more testing machines. In addition, the invention provides for a system and method that provides test scripts execution status and reports via one or more communication channels to facilitate remote monitoring of test scripts execution. Also, the invention provides for a system and method that facilitates quality engineering and ensures test effectiveness.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

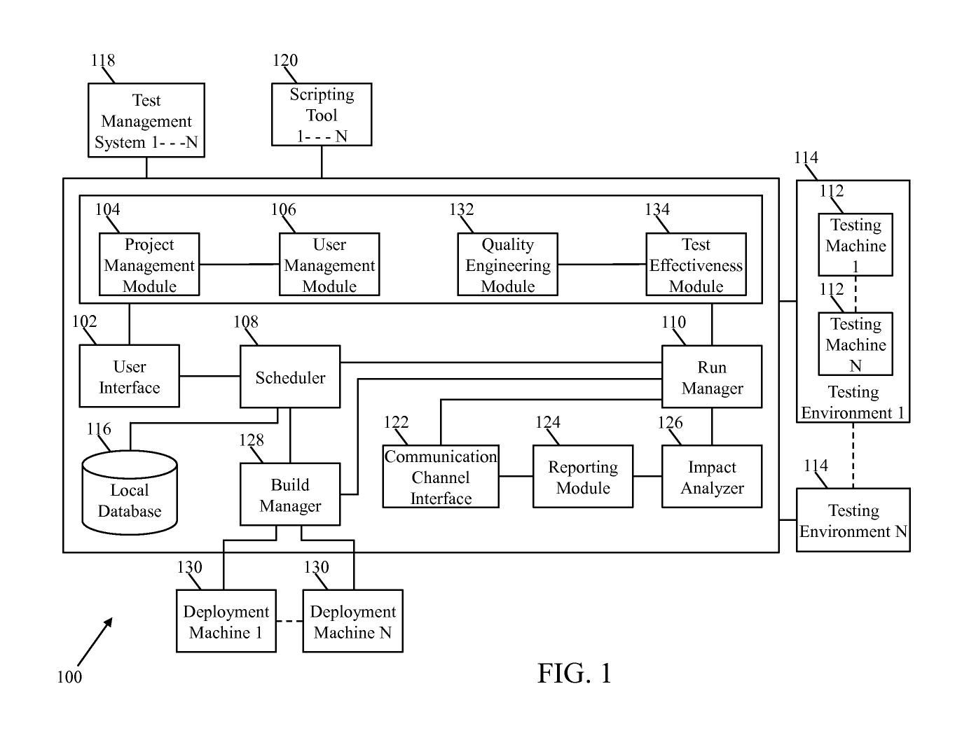

FIG. 1 is a block diagram illustrating a web based system 100 for automating build deployment and testing processes, in accordance with an embodiment of the present invention. The system 100 comprises a user interface 102, a project management module 104, a user management module 106, a scheduler 108, a run manager 110, a local database 116, a communication channel interface 122, a reporting module 124, an impact analyzer module 126, a build manager 128, a quality engineering module 132 and a test effectiveness module 134.

The user interface 102 is configured to facilitate one or more users to provide one or more input parameters for build deployment and testing code associated with newly developed system. In an embodiment of the present invention, the one or more users include, but not limited to, testers and software developers. In an embodiment of the present invention, multiple users can simultaneously access the system 100. In an embodiment of the present invention, the one or more input parameters include, but not limited to, project selection, build and deployment selection, date and time of execution of test scripts associated with the selected project, duration of execution, release notes associated with the selected project, information to identify the appropriate test scripts to be executed and any other information relevant for test scripts execution.

In an embodiment of the present invention, the user interface 102 provides options to the one or more users to select a project from a list of projects rendered by the project management module 104. The project management module 104 also facilitates one or more administrators to configure one or more projects and edit, modify and delete one or more pre-configured projects in the system 100.

In an embodiment of the present invention, the user interface 102 also provides options, rendered by the user management module 106, to facilitate managing the one or more users accessing the system 100. The user management module 106 is configured to facilitate the one or more administrators to monitor and give access rights to the one or more users for the one or more projects. The user management module 106 is further configured to facilitate the administrator to associate a particular user to the one or more projects. In an embodiment of the present invention, the one or more users access the system 100 via the user interface 102 and select the appropriate project from the list of projects rendered on the user interface 102. In an embodiment of the present invention, the project management module 104 facilitates the one or more users to configure the one or more projects based on the user requirements to facilitate test scripts execution. In an exemplary embodiment of the present invention, the one or more users may configure the time duration for which the system 100 should wait prior to re-assigning the one or more test scripts that are not responding on one or more testing machines 112.

In an embodiment of the present invention, the one or more test scripts are a set of instructions written using a scripting or programming language such as, but not limited to, C++, C#, Tcl, Expect, Java, Hypertext Preprocessor (PHP), Perl, Powershell, Python and Ruby. The one or more test scripts are used for automated testing and are executed on a newly developed system under test to verify that the code associated with the system under test performs in an expected manner. In an embodiment of the present invention, the newly developed system under test includes, but not limited to, utility software, application software and system software. In an embodiment of the present invention, the one or more users may provide the date and time for execution of the one or more test scripts via the user interface 102 for a particular project. In an embodiment of the present invention, the information to identify the one or more test scripts provided by the one or more users may include, but not limited to, names of the test cases whose corresponding test scripts are to be executed.

In an embodiment of the present invention, the one or more users can schedule test scripts execution based on user requirements by selecting an appropriate option rendered on the user interface 102. In another embodiment of the present invention, the one or more users can select one or more test cases from a list of test cases rendered on the user interface 102 to execute the test scripts corresponding to the selected one or more test cases. In an exemplary embodiment of the present invention, various test cases include procedures for testing various functionalities such as, but not limited to, login functionality, data export functionality, application interaction with one or more databases functionality and any other functionality of the system and associated code under test. In yet another embodiment of the present invention, the one or more users can select one or more test suites from a list of test suites rendered on the user interface 102 to facilitate scheduling and executing all the test scripts associated with test cases of the selected one or more test suites.

In an embodiment of the present invention, the one or more users may schedule execution by sending one or more standard messages via one or more communication channels such as, but not limited to, emails and Short Messaging Service (SMS). The one or more standard messages comprise one or more input parameters that facilitate the scheduler 108 in automatically scheduling execution of the one or more test scripts without manually providing the one or more input parameters via the user interface 102.

The scheduler 108 is configured to schedule execution of the one or more test scripts for testing the code based on the one or more input parameters such as, but not limited to, information related to the test scripts and the date and time of execution provided by the one or more users via the user interface 102 and via the one or more standard messages. In an embodiment of the present invention, the scheduler 108 communicates with one or more test management systems 118 to facilitate scheduling. In another embodiment of the present invention, the scheduler 108 communicates with the one or more scripting tools 120 to facilitate scheduling. Once the one or more test scripts are scheduled for execution by the scheduler 108, the scheduler 108 starts communicating with the run manager 110 to facilitate assigning the one or more test scripts to one or more testing machines 112 based on execution schedule. In an embodiment of the present invention, the execution schedule generated by the scheduler 108 contains at least: information related to time and order of execution of each of the one or more test scripts.

In an embodiment of the present invention, the scheduler 108 provides one or more options related to scheduling and execution such as, but not limited to, scheduling test scripts execution after build and deployment, scheduling test scripts execution without build and deployment, selecting testing environments 114 for test scripts execution, selecting testing machines 112 for executing particular test scripts and prioritizing test scripts and test suite execution via the user interface 102. Further, the one or more options related to the scheduling and execution facilitate the one or more users to schedule the execution of test scripts as per the user requirements, preferences and for providing flexibility to the one or more users.

In an embodiment of the present invention, the scheduler 108 communicates with the local database 116 to extract metadata corresponding to the test scripts to be executed. Further, the metadata is stored in the local database 116 by the one or more administrators at the time of configuring the system 100 with the one or more test management systems 118 and the one or more scripting tools 120. Furthermore, the metadata is extracted based on the one or more input parameters provided by the one or more users. The extracted metadata contains address and path of the one or more test scripts residing in the one or more test management system 118 or the one or more scripting tools 120 which facilitates in identifying the test scripts to be assigned by the run manager 110 for execution. In another embodiment of the present invention, names of the test cases rendered on the user interface 102 are mapped with the associated one or more test scripts residing in the one or more test management systems 118 or the one or more scripting tools 120 which facilitates in identifying the test scripts to be assigned by the run manager 110 for execution. Further, mapping of the names of the test cases with the one or more test scripts is performed by the one or more administrators at the time of configuring the system 100.

The run manager 110 is configured to assign the one or more test scripts to the one or more testing machines 112 for execution based on the execution schedule. In an embodiment of the present invention, the one or more testing machines 112 are a combination of software and hardware components on which the one or more test scripts are executed for automated testing. In an embodiment of the present invention, the one or more testing machines 112 reside in one or more testing environments 114. The one or more testing environments 114 are used to run and test the code associated with the newly developed system using the one or more testing machines 112. The testing environment 114 comprises various components including, but not limited to, server operating systems, client operating systems, database servers, browser in case of web application and any other hardware and software components. In an embodiment of the present invention, a Virtual Desktop Infrastructure (VDI) providing multiple desktops is deployed as the testing environment 114. Further, the multiple desktops act as the one or more testing machines 112. In various embodiments of the present invention, the one or more testing machines 112 include, but not limited to, remote desktops, physical desktops, virtual desktops and any other machines associated with any testing framework which are exposed to internet and capable of connecting with the system 100.

In an embodiment of the present invention, the run manager 110 facilitates in executing the one or more test scripts residing in the one or more test management systems 118 connected to the system 100. In various embodiments of the present invention, the one or more test management systems 118 include, but not limited to, Hewlett-Packard (HP) Quality Center, IBM Rational Quality Manager, Enterprise tester, Testersuite and Zephyr. In another embodiment of the present invention, the run manager 110 accesses the one or more test scripts from the one or more scripting tools 120 connected to the system 100. A scripting tool 120 is an external test script generator which facilitates automatic generation of the one or more test scripts in the one or more programming or scripting languages. In various embodiments of the present invention, the one or more scripting tools 120 include, but not limited to, HP QuickTest Professional (QTP), Selenium and Web Application Testing In Ruby (WATIR). In an embodiment of the present invention, the one or more scripting tools 120 may communicate with the one or more test management systems 118.

In an embodiment of the present invention, the run manager 110 checks availability of the one or more testing machines 112 and then assigns the one or more test scripts to the one or more testing machines 112 based on the execution schedule. In an embodiment of the present invention, checking the availability of the one or more testing machines 112 facilitates effective load distribution. Further, effective load distribution results in optimized usage of the various testing machines 112 and reduces the need of additional testing machines 112 in case number of test scripts to be executed increases. In an embodiment of the present invention, the run manager 110 monitors availability of the one or more testing environments 114 based on the user preferences and execution schedule. In an embodiment of the present invention, the run manager 110 also monitors the availability of the other testing environments 114 to assign the one or more unassigned test scripts.

Once the one or more test scripts are assigned to the one or more testing machines 112, the one or more testing machines 112 start executing the one or more test scripts. During execution, the run manager 110 monitors execution status of the one or more test scripts. In an embodiment of the present invention, monitoring the execution status of the one or more test scripts facilitates the run manager 110 to track availability of the one or more testing machines 112. Also, if the execution of a current test script halts due to pop-up windows or any other reasons related to a particular testing machine 112 that cannot be resolved by the current test script, then the run manager 110 facilitates in re-assigning the current test script and the subsequent test scripts assigned to the particular testing machine 112 to next available testing machine 112 configured for execution. In an embodiment of the present invention, the run manager 110 re-assigns the current test script and the subsequent test scripts after waiting for a certain interval of time. Further, the one or more users may configure the time interval for which the run manager 110 waits before re-assigning the current test script on a particular testing machine 112.

In an embodiment of the present invention, the run manager 110 renders options on the user interface 102 to facilitate the one or more users associated to a particular project to manage execution of the one or more test scripts for the particular project. In an embodiment of the present invention, the run manager 110 interacts with the user interface 102 to facilitate the one or more users to pause and re-start test scripts execution via the user interface 102. In an embodiment of the present invention, the pause and re-start options facilitate in achieving test environment isolation during testing. In an embodiment of the present invention, the run manager 110 also provides relevant information related to test scripts execution to the reporting module 124 to facilitate the reporting module 124 in generating one or more reports related to the test scripts execution.

In an embodiment of the present invention, the run manager 110 sends the execution status to the one or more test management systems 118. The execution status comprise at least one of: information related to number of executed test scripts, number of failed test scripts, execution time, running test scripts, pending test scripts and testing machines utilization. In another embodiment of the present invention, the run manager 110 facilitates in providing the execution status to the one or more users via the user interface 102. In yet another embodiment of the present invention, the run manager 110 sends the execution status to the one or more users via various communication channels.

The communication channel interface 122 is configured to facilitate the run manager 110 to send the execution status updates to the one or more users via the one or more communication channels. In an embodiment of the present invention, the communication channel interface 122 connects with the one or more communication channels for sending updates. In an embodiment of the present invention, the one or more communication channels include, but not limited to, SMS, electronic mail, facsimile and Unstructured Supplementary Data Service (USSD). In an embodiment of the present invention, the communication channel interface 122 also facilitates in receiving the one or more standard messages sent by the one or more users via the one or more communication channels to remotely schedule test scripts execution.

The reporting module 124 is configured to generate the one or more reports related to build deployment and test scripts execution. The reporting module 124 is also configured to render the generated one or more reports on the user interface 102 to facilitate the one or more users to access the generated one or more reports. In an embodiment of the present invention, the one or more reports related to test scripts execution are generated using the information related to test scripts execution provided by the run manager 110. In an embodiment of the present invention, the one or more reports related to test scripts execution include, but not limited to, running test scripts report, pending test scripts report, test-scripts wise report, test execution time report, test comparison report, test scripts failure report, defect trend report and testing machine utilization report. In an exemplary embodiment of the present invention, the reporting module 124 uses Apache POI for generating the one or more reports in one or more Microsoft (MS) Office formats such as, but not limited to, MS Word and MS Excel.

In an embodiment of the present invention, the user interface 102 provides one or more options to the one or more users to access the one or more reports comprising execution status for a particular interval of time such as, but not limited to, daily, monthly and during release. In another embodiment of the present invention, the one or more users can select one or more options via the user interface 102 to access the one or more reports comprising details related to a particular testing machine 112. In yet another embodiment of the present invention, the one or more users may select an option provided by the user interface 102 to access one or more reports comprising information related to each of the one or more testing machines 112.

The impact analyzer 126 is configured to assist the run manager 110 in monitoring and analyzing test scripts execution. In an embodiment of the present invention, the impact analyzer 126 analyzes the total number of test scripts for a particular execution schedule and removes duplicated test scripts. The impact analyzer 126 also facilitates in ensuring that the one or more test scripts are not executed multiple times.

The build manager 128 is configured to connect with the one or more deployment machines 130 to facilitate automatic build and deployment of the code associated with the system being tested. In an embodiment of the present invention, build refers to the process of compiling and linking the code and corresponding files in an order that is appropriate for deployment. Once the build process is completed, the compiled and linked code is deployed on the one or more deployment machines 130. In an embodiment of the present invention, the deployment process refers to various activities that facilitate availability of the newly developed system for use. Further, various activities associated with deployment include, but not limited to, release, installation, activation, de-activation, adaptation and version tracking. In an embodiment of the present invention, each of the one or more deployment machines 130 have pre-installed build clients which facilitate connection with the build manager 128. In an embodiment of the present invention, the one or more users can facilitate automating build and deployment by selecting the appropriate option for build and deployment at the time of scheduling via the user interface 102. Further, the build manager 128 provides information related to build deployment to the reporting module 124 to facilitate the reporting module 124 to generate one or more reports related to build deployment.

The quality engineering module 132 is configured to check quality and coverage of the code associated with the newly developed system under test. In an embodiment of the present invention, the quality engineering module 132 analyzes the code to identify defects and inefficiencies in the code such as, but not limited to, bugs, unused codes, overcomplicated code, empty if/while statements, suboptimal code and duplicate code. The quality engineering module 132 is also configured to check if the developer developing the code has followed best practices and standards for developing the code. Further, the quality engineering module 132 also detects copied and pasted portions of the code. Furthermore, the quality engineering module 132 checks and detects format and style errors and violations in the code. Once the quality engineering module 132 has analyzed the code, the quality engineering module 132 facilitates generating code quality reports that can be accessed by the one or more users via the user interface 102. In an embodiment of the present invention, the quality engineering module 132 is configured to check the quality of the code being tested after build and deployment if the one or more users have selected the option for build and deployment.

Once the test scripts are executed, the quality engineering module 132 is also configured to check and determine code coverage to ensure that the executed test scripts adequately cover the code being tested. In an embodiment of the present invention, the quality engineering module 132 facilitates in determining the degree to which the code associated with the newly developed system has been tested by the test scripts and corresponding test cases. The quality engineering module 132 then determines the percentage of the code covered by the one or more test scripts and highlights the code which is not covered by any of the executed test scripts. In an embodiment of the present invention, the quality engineering module 132 determines the lines of code covered by each of the one or more test scripts. In an embodiment of the present invention, the one or more users can access the code coverage results via the user interface 102. In another embodiment of the present invention, the quality engineering module 132 generates one or more code coverage reports that can be accessed by the one or more users.

The test effectiveness module 134 is configured to analyze the test cases and associated test scripts to determine the effectiveness of each of the one or more test cases and associated one or more test scripts using the code coverage results generated by the quality engineering module 132. In an embodiment of the present invention, the test effectiveness module 134 facilitates the one or more users to analyze the code coverage and effectiveness of each of the one or more test cases to generate test effectiveness results. The test effectiveness module 134 further facilitates in analyzing and comparing two or more test cases and highlighting redundant test cases. In an embodiment of the present invention, the test effectiveness module 134 facilitates the one or more users to compare two or more test cases and check for overlapping lines of code via the user interface 102. In another embodiment of the present invention, the test effectiveness module 134 facilitates evaluating and then rendering the percentage of the code covered by each of the one or more test cases on the user interface 102.

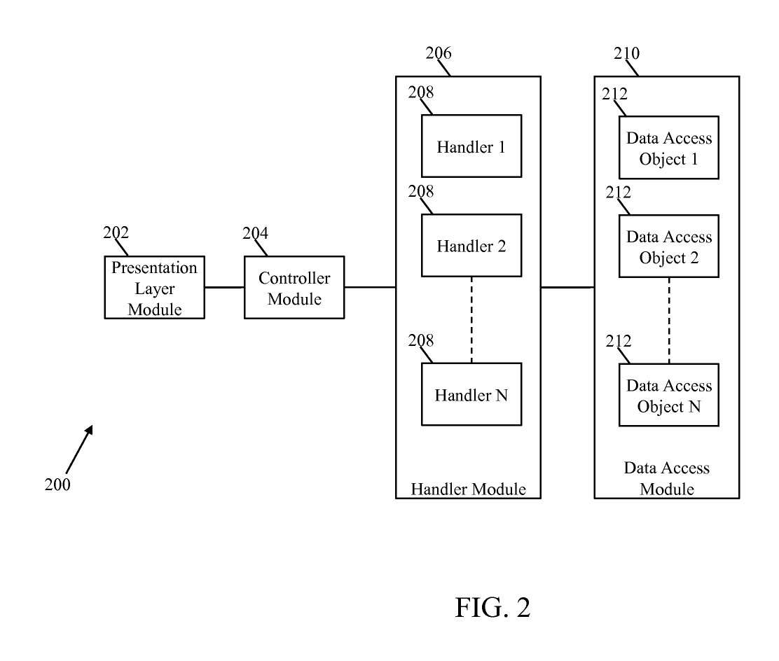

FIG. 2 illustrates an exemplary architecture framework for automating build deployment and testing processes related to development of software, in accordance with an embodiment of the present invention. The architecture framework 200 comprises a presentation layer module 202, a controller module 204, a handler module 206 and a data access module 210. In an exemplary embodiment of the present invention, the architecture framework 200 is based on Spring Model-View-Controller (MVC) framework.

The presentation layer module 202 comprises a user interface 102 (FIG. 1) which provides an interface to the one or more users to submit one or more requests to the controller module 204. In an embodiment of the present invention, the one or more requests comprise one or more request objects which are received by the controller module 204 via the presentation layer module 202. Further, each of the one or more requests has its associated request handler id. In an embodiment of the present invention, the one or more submitted requests corresponds to an action such as, but not limited to, scheduling the one or more test scripts, pausing execution of the one or more test scripts, re-starting execution of the one or more test scripts, viewing execution status and viewing the one or more reports related to test scripts execution via the user interface 102 (FIG. 1).

The controller module 204 receives the one or more requests and associated request handler id from the presentation layer module 202. The controller module 204 then forwards the request handler id to an appropriate handler 208 configured to process the received request. The handler module 206 comprises various handlers 208 configured to handle a specific request.

Once a particular handler 208 receives the request handler id, the handler 208 delegates the received request to the appropriate data access object 212 corresponding to the received request.

The data access module 210 comprises one or more data access objects 212 configured to access relevant data corresponding to the one or more requests received from the one or more handlers 208. The data access objects have corresponding pre-stored Structured Query Languages (SQL) queries and stored procedures that facilitate in accessing the relevant data residing in the local database 116 (FIG. 1). In an embodiment of the present invention, the one or more data access objects 212 call the local database 116 (FIG. 1) to retrieve the required data corresponding to the received request. In an embodiment of the present invention, once the required data is retrieved, the handler module 206 facilitates further processing using the retrieved data. In an exemplary embodiment of the present invention, the handler module 206 processes the retrieved data using Apache POI (not shown) to generate appropriate MS office files in case the one or more users need to view the processed data in the form of MS office formats such as, but not limited to, MS Word, MS Excel and MS PowerPoint (PPT). The generated MS office files are then sent to the presentation layer module 202.

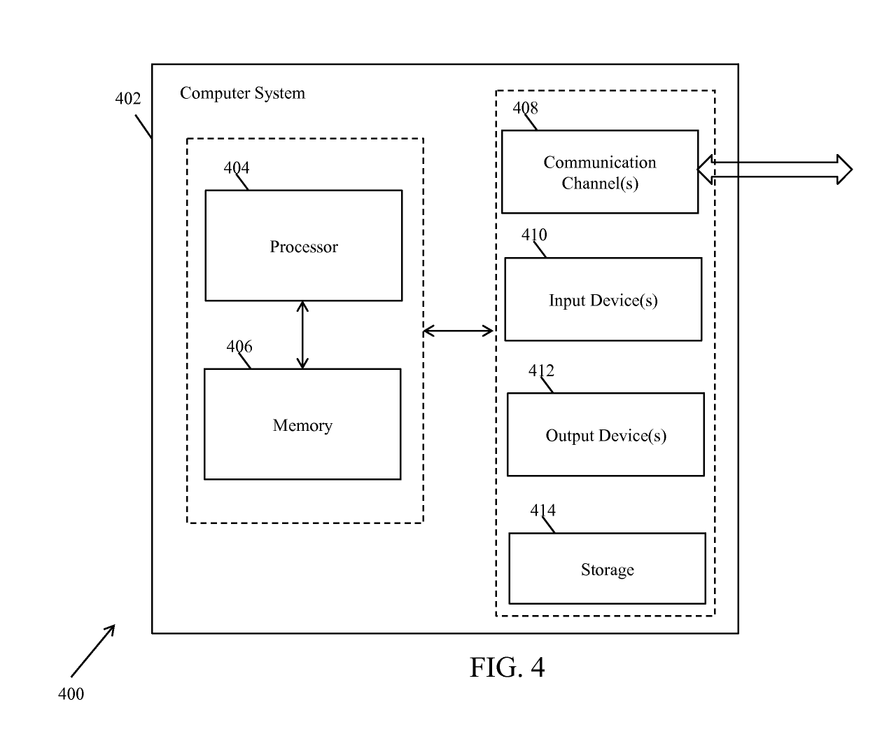

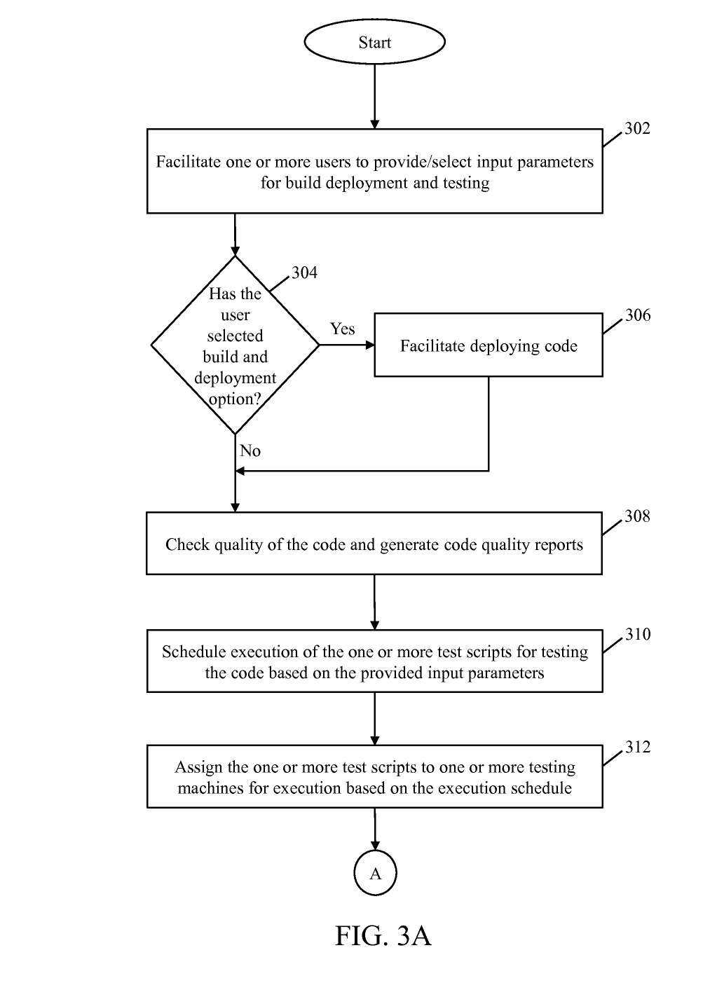

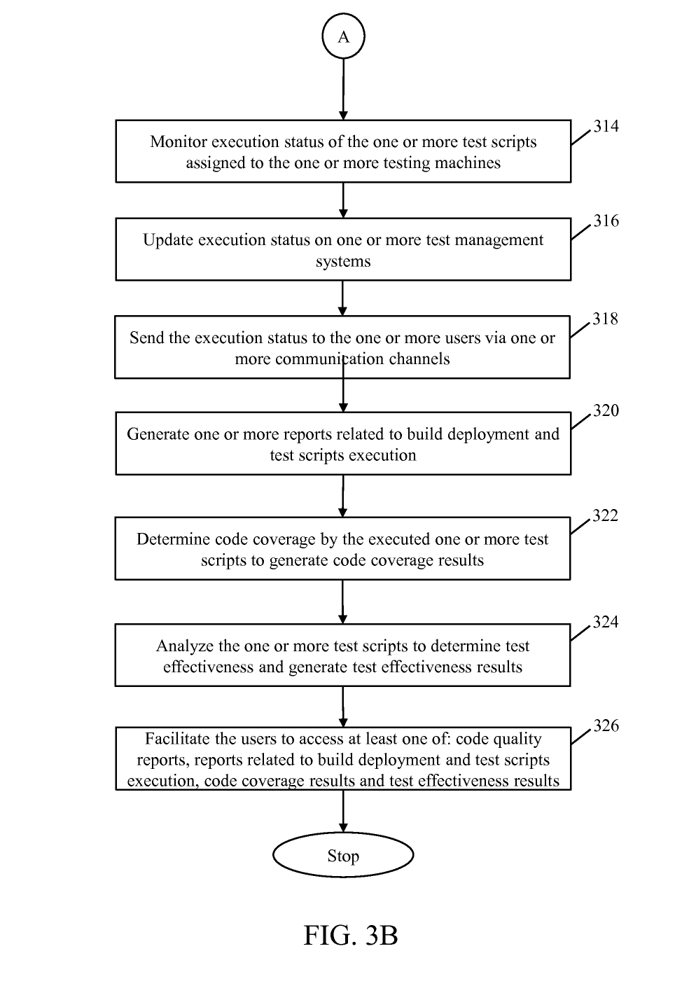

FIGS. 3A and 3B represent a flowchart illustrating a method for automating build deployment and testing processes related to development of software, in accordance with an embodiment of the present invention.

At step 302, one or more users are facilitated to provide/select one or more input parameters for build deployment and testing the code associated with newly developed system. In an embodiment of the present invention, the one or more users provide/select the one or more input parameters via a user interface. In another embodiment of the present invention, the one or more users provide one or more input parameters by sending one or more standard messages via one or more communication channels such as, but not limited to, Short Messaging Service (SMS) and electronic mail. In an embodiment of the present invention, the one or more users include, but not limited to, testers and software developers. In an embodiment of the present invention, the one or more input parameters include, but not limited to, project selection, build and deployment selection, date and time of execution of test scripts associated with the selected project, duration of execution, release notes associated with the selected project, information to identify the appropriate test scripts to be executed and any other information relevant for test scripts execution.

In an embodiment of the present invention, the one or more users may provide the date and time for execution based on the build and deployment process. In an embodiment of the present invention, the one or more input parameters facilitate scheduling execution of one or more test scripts. In an embodiment of the present invention, the one or more test scripts are a set of instructions written using a scripting or programming language such as, but not limited to, C++, C#, Tcl, Expect, Java, Hypertext Preprocessor (PHP), Perl, Powershell, Python and Ruby. The one or more test scripts are used for automated testing and are executed on a system under test to verify that the system and associated code being tested performs in an expected manner. In an embodiment of the present invention, the newly developed system under test includes, but not limited to, utility software, application software and system software.

At step 304, a check is performed to ascertain whether the one or more users have selected build and deployment option. If it is ascertained that the one or more users have selected build and deployment option, then at step 306, automatic build and deployment of the code associated with the newly developed system is facilitated. In an embodiment of the present invention, build refers to the process of compiling and linking the code and its corresponding files in an order that is appropriate for deployment. Once the build process is completed, the compiled and linked code is deployed on one or more deployment machines. In an embodiment of the present invention, the deployment process refers to various activities that facilitate availability of the newly developed system for use. Further, various activities associated with deployment include, but not limited to, release, installation, activation, de-activation, adaptation and version tracking. Once build and deployment processes are completed, the control is transferred to step 308.

If it is ascertained that the one or more users have not selected build and deployment option, then also the control is transferred to step 308. At step 308, quality of the code is checked and code quality reports are generated. In an embodiment of the present invention, the code is analyzed to identify defects and inefficiencies in the code such as, but not limited to, bugs, unused codes, overcomplicated code, empty if/while statements, suboptimal code and duplicate code. Further, a check is also performed to ascertain if the developer developing the code has followed best practices and standards for developing the code. Furthermore, copied and pasted portions of the code are also detected. In addition, format and style errors and violations in the code are also detected. Once the code quality has been checked, the one or more code quality reports are generated. In an embodiment of the present invention, the one or more code quality reports highlight the defects and inefficiencies in the code. In another embodiment of the present invention, the one or more code quality reports highlight the copied and pasted portions of the code. In an embodiment of the present invention, the one or more users access the one or more code quality reports via the user interface. In another embodiment of the present invention, the one or more code quality reports are sent to the one or more users via one or more communication channels.

At step 310, execution of the one or more test scripts for testing the code is scheduled based on the one or more input parameters. In an embodiment of the present invention, the one or more test scripts to be executed are identified based on the information related to the test scripts provided by the one or more users. Once the one or more test scripts to be executed are identified, the one or more identified test scripts are scheduled for execution based on the date and time of execution provided by the one or more users.

At step 312, the one or more test scripts are assigned to one or more testing machines for execution based on execution schedule. In an embodiment of the present invention, the execution schedule contains at least: information related to time and order of execution of each of the one or more test scripts. In an embodiment of the present invention, the one or more testing machines are a combination of software and hardware components on which the one or more test scripts are executed for automated testing. In an embodiment of the present invention, the one or more testing machines reside in a testing environment. In various embodiments of the present invention, the one or more testing machines include, but not limited to, remote desktops, physical desktops, virtual desktops and any other machines associated with any testing framework.

In an exemplary embodiment of the present invention, a Virtual Desktop Infrastructure (VDI) providing multiple desktops is deployed as the testing environment. Further, the multiple desktops act as the one or more testing machines. In an embodiment of the present invention, the availability of the one or more testing machines is checked and the one or more test scripts are assigned to the one or more testing machines based on the availability to facilitate effective load balancing.

In an embodiment of the present invention, the one or more test scripts reside in the one or more test management systems. In various embodiments of the present invention, the one or more test management systems include, but not limited to, Hewlett-Packard (HP) Quality Center, IBM Rational Quality Manager, Enterprise tester, Testersuite and Zephyr. In another embodiment of the present invention, the one or more test scripts reside in one or more scripting tools. A scripting tool is an external test script generator which facilitates automatic generation of the one or more test scripts in the one or more programming or scripting languages. In various embodiments of the present invention, the one or more scripting tools include, but not limited to, HP QuickTest Professional (QTP), Selenium and Web Application Testing In Ruby (WATIR).

Once the one or more test scripts are assigned to the one or more testing machines, the one or more testing machines start executing the one or more test scripts.

At step 314, execution status of the one or more test scripts assigned to the one or more testing machines is monitored. In an embodiment of the present invention, monitoring the execution status of the one or more test scripts facilitates in tracking availability of the one or more testing machines. Also, if the execution of a current test script halts due to pop-up windows or any other reasons related to a particular testing machine which cannot be resolved by the current test script, then the current test script and the subsequent test scripts assigned to the particular testing machine are re-assigned to next available testing machine configured for execution. In an embodiment of the present invention, the one or more users can also manage execution of the test scripts on the various testing machines via the user interface. The user interface provides one or more options to the one or more users to pause and re-start test scripts execution. In an embodiment of the present invention, the pause and re-start options facilitate in achieving test environment isolation during testing.

At step 316, execution statuses of the one or more test scripts are updated on the one or more test management systems. In an embodiment of the present invention, the execution status comprise at least one of: information related to number of executed test scripts, number of failed test scripts, execution time, running test scripts, pending test scripts and testing machines utilization. At step 318, the execution statuses are sent to the one or more users via one or more communication channels. In an embodiment of the present invention, the one or more communication channels include, but not limited to, SMS, electronic mail, facsimile and Unstructured Supplementary Data Service (USSD).

At step 320, one or more reports related to build deployment and test scripts execution are generated. In an embodiment of the present invention, the one or more reports are generated using information related to test scripts execution and the execution status.

At step 322, code coverage by the executed one or more test scripts is determined to generate code coverage results. In an embodiment of the present invention, code coverage is determined to ensure that the executed test scripts adequately cover the code being tested. In an embodiment of the present invention, percentage of the code covered by the one or more test scripts is determined and the code which is not covered by any of the executed test scripts is highlighted. Further, the code covered by each of the one or more test scripts is also determined. In an embodiment of the present invention, the one or more users can access the code coverage results via the user interface.

At step 324, the one or more test scripts are analyzed to determine test effectiveness and generate test effectiveness results. In an exemplary embodiment of the present invention, the one or more users can compare two or more test cases and check for overlapping lines of code via the user interface. In another embodiment of the present invention, the percentage of the code covered by each of the one or more test cases is evaluated and rendered on the user interface.

At step 326, the one or more users access at least one of: code quality reports, reports related to build deployment and test scripts execution, code coverage results and test effectiveness results via the user interface. In an embodiment of the present invention, the one or more reports related to test scripts execution include, but not limited to, running test scripts report, pending test scripts report, test-scripts wise report, test execution time report, test comparison report, test scripts failure report, defect trend report, and testing machine utilization report. In an embodiment of the present invention, the user interface provides one or more options to the one or more users to access the one or more reports providing execution status for a particular interval of time such as, but not limited to, daily, monthly and during release/deployment. In another embodiment of the present invention, the one or more users can select one or more options via the user interface to access the one or more reports comprising details related to a particular testing machine. In yet another embodiment of the present invention, the one or more users may select an option provided by the user interface to access one or more reports comprising information related to each of the one or more testing machines.

FIG. 4 illustrates an exemplary computer system in which various embodiments of the present invention may be implemented.

The computer system 402 comprises a processor 404 and a memory 404. The processor 404 executes program instructions and may be a real processor. The processor 404 may also be a virtual processor. The computer system 402 is not intended to suggest any limitation as to scope of use or functionality of described embodiments. For example, the computer system 402 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing various embodiments of the present invention. The computer system 402 may have additional components. For example, the computer system 402 includes one or more communication channels 408, one or more input devices 410, one or more output devices 412, and storage 414. An interconnection mechanism (not shown) such as a bus, controller, or network, interconnects the components of the computer system 402. In various embodiments of the present invention, operating system software (not shown) provides an operating environment for various softwares executing in the computer system 402, and manages different functionalities of the components of the computer system 402.

The communication channel(s) 408 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 410 may include, but not limited to, a keyboard, mouse, pen, joystick, trackball, a voice device, a scanning device, or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 402.

The storage 414 may include, but not limited to, magnetic disks, magnetic tapes, CD-ROMs, CD-RWs, DVDs, flash drives or any other medium which can be used to store information and can be accessed by the computer system 402. In various embodiments of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but not limited to optical or analogue communications channel(s) 408. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for automating build deployment and testing processes related to development of software, the system comprising:
a user interface configured to facilitate one or more users to provide one or more input parameters for build deployment and testing;
a build manager configured to facilitate deploying code if the one or more users provide the one or more input parameters related to build deployment;
a scheduler configured to schedule execution of one or more test scripts for testing the code based on the one or more input parameters provided by the one or more users;
a run manager configured to:
assign the one or more test scripts to one or more testing machines for execution based on execution schedule;
monitor execution status of each of the one or more test scripts; and
send the execution status to one or more test management systems and the one or more users via one or more communication channels; and
a reporting module configured to generate one or more reports related to build deployment and test scripts execution.

2. The system of claim 1 wherein assigning the one or more test scripts to the one or more testing machines is based on availability of the one or more testing machines to facilitate effective load distribution.

3. The system of claim 1 further comprising a quality engineering module configured to check at least one of: quality and coverage of the code and further configured to generate at least one of: code quality reports and code coverage results.

4. The system of claim 1 further comprising a test effectiveness module configured to determine test effectiveness and further configured to generate test effectiveness results.

5. The system of claim 1 further comprising an impact analyzer configured to analyze the one or more test scripts scheduled for execution and remove one or more duplicated test scripts.

6. The system of claim 1 wherein the one or more test scripts are used to verify the code associated with a system under test.

7. The system of claim 1 wherein the one or more testing machines reside in one or more testing environments.

8. The system of claim 1 wherein the one or more input parameters include at least one of: project selection, selecting build and deployment options, date and time of execution of test scripts, duration of execution, release notes, information to identify the appropriate test scripts for execution and any other information relevant for test scripts execution.

9. The system of claim 1 wherein the execution schedule generated by the scheduler contains at least information related to time and order of execution of each of the one or more test scripts.

10. The system of claim 1 wherein monitoring the execution status of each of the one or more test scripts comprise at least one of: monitoring each of the one or more testing machines, tracking availability of each of the one or more testing machines and re-assigning the one or more test scripts to one or more testing machines.

11. The system of claim 1 wherein the run manager provides options to the one or more users to pause and re-start test scripts execution via the user interface.

12. The system of claim 1 wherein the run manager is configured to re-assign the one or more test scripts being executed to one or more different testing machines if the one or more test scripts halt during execution.

13. The system of claim 1 wherein the execution status comprise at least one of: information related to number of executed test scripts, number of failed test scripts, execution time, running test scripts, pending test scripts and testing machines utilization.

14. The system of claim 1 wherein the one or more communication channels include at least one of: electronic mail, Short Messaging Service (SMS), facsimile and Unstructured Supplementary Data Service (USSD).

15. The system of claim 1 wherein the one or more reports related to test scripts execution include at least one of: running test scripts report, pending test scripts report, executed test scripts report, execution time report, test comparison report, test scripts failure report, defect trend report and testing machine utilization report.

16. A computer-implemented method for automating build deployment and testing processes related to development of software, via program instructions stored in a memory and executed by a processor, the computer-implemented method comprising:
facilitating one or more users to provide one or more input parameters for build deployment and testing;
facilitating deploying code if the one or more users provide the one or more input parameters related to build deployment;
scheduling execution of one or more test scripts for testing the code based on the one or more input parameters provided by the one or more users;
assigning the one or more test scripts to one or more testing machines for execution based on execution schedule and monitoring execution status of each of the one or more test scripts;
sending the execution status to one or more test management systems and the one or more users via one or more communication channels; and
generating one or more reports related to build deployment and test scripts execution.

17. The computer-implemented method of claim 16 wherein assigning the one or more test scripts to the one or more testing machines is based on availability of the one or more testing machines to facilitate effective load distribution.

18. The computer-implemented method of claim 16 further comprising analyzing the one or more test scripts scheduled for execution and removing one or more duplicated test scripts.

19. The computer-implemented method of claim 16 further comprising checking at least one of: quality and coverage of the code and generating at least one of: code quality reports and code coverage results.

20. The computer-implemented method of claim 16 further comprising determining test effectiveness and generating test effectiveness results.

21. The computer-implemented method of claim 16 further comprising facilitating the one or more users to access the one or more reports related to build deployment and test scripts execution.

22. The computer-implemented method of claim 16 wherein the one or more testing machines reside in one or more testing environments.

23. The computer-implemented method of claim 16 wherein the one or more input parameters include at least one of: project selection, selecting build and deployment options, date and time of execution of test scripts, duration of execution, release notes, information to identify the appropriate test scripts to be executed and any other information relevant for test scripts execution.

24. The computer-implemented method of claim 16 wherein the one or more users provide the one or more input parameters by sending one or more standard messages via one or more communication channels including at least one of: Short Messaging Service (SMS) and electronic mail.

25. The computer-implemented method of claim 16 wherein the execution schedule contains at least: information related to time and order of execution of each of the one or more test scripts.

26. The computer-implemented method of claim 16 wherein monitoring the execution status of each of the one or more test scripts comprise at least one of: monitoring each of the one or more testing machines, tracking availability of each of the one or more testing machines and re-assigning the one or more test scripts to different testing machines.

27. The computer-implemented method of claim 16 further comprising re-assigning at least one of: the one or more test scripts being executed to one or more different testing machines if the one or more test scripts halt during execution.

28. The computer-implemented method of claim 16 wherein the execution status comprise at least one of: information related to number of executed test scripts, number of failed test scripts, execution time, running test scripts, pending test scripts and testing machines utilization.

29. The computer-implemented method of claim 16 wherein the one or more communication channels include at least one of: electronic mail, Short Messaging Service (SMS), facsimile and Unstructured Supplementary Data Service (USSD).

30. A computer program product for automating build deployment and testing processes related to development of software, the computer program product comprising:
a non-transitory computer-readable medium having computer-readable program code stored thereon, the computer-readable program code comprising instructions that when executed by a processor, cause the processor to:
facilitate one or more users to provide one or more input parameters for build deployment and testing;
facilitate deploying code if the one or more users provide the one or more input parameters related to build deployment;
schedule execution of one or more test scripts for testing the code based on the one or more input parameters provided by the one or more users;
assign the one or more test scripts to one or more testing machines for execution based on execution schedule and monitor execution status of each of the one or more test scripts;
send the execution status to one or more test management systems and the one or more users via one or more communication channels; and
generate one or more reports related to build deployment and test scripts execution.

31. The computer program product of claim 30, wherein assigning the one or more test scripts to the one or more testing machines is based on availability of the one or more testing machines to facilitate effective load distribution.

32. The computer program product of claim 30 further comprising analyzing the one or more test scripts scheduled for execution and removing one or more duplicated test scripts.

33. The computer program product of claim 30 further comprising checking at least one of: quality and coverage of the code and generating at least one of: code quality reports and code coverage results.

34. The computer program product of claim 30 further comprising determining test effectiveness and generating test effectiveness results.

35. The computer program product of claim 30 further comprising facilitating the one or more users to access the one or more reports related to build deployment and test scripts execution.

36. The computer program product of claim 30 wherein the one or more testing machines reside in one or more testing environments.

37. The computer program product of claim 30 further comprising re-assigning at least one of: the one or more test scripts being executed to one or more different testing machines if the one or more test scripts halt during execution.
